(19) United States
(12) Patent Application Publication
(10) Pub. No.: US 2012/0067372 A1
(43) Pub. Date: Mar. 22, 2012

(54) MINIMAL ENTRY METHOD AND APPARATUS FOR CLEANING FLUID CONTAINERS

(75) Inventors: Raymond R. O'Quinn, Spring, TX (US); Raymond A. Frisby, Tomball, TX (US); Norman D. Eger, Baton Rouge, LA (US); Michael C. Farquhar, Broussard, LA (US); Brett A. Boyd, Lafayette, LA (US); Martin Gilbert, Brechin (GB)

(73) Assignee: BAKER HUGHES INCORPORATED, Houston, TX (US)

(21) Appl. No.: 12/887,036

(22) Filed: Sep. 21, 2010

(51) Int. Cl. B08B 3/04

(52) U.S. Cl. 134/10; 134/104.2

(57) ABSTRACT

A system for cleaning a container may include: a fluid source; an arm that moves a nozzle in at least two directions; a fluid retrieval device; a separator; and a fluid mover. One method for cleaning includes securing an arm to a support positioned at least partially outside of the container; spraying a fluid onto an inner surface of the container using the nozzle; drawing the fluid and an entrained material out of the container using the fluid retrieval device; removing at least some of the entrained material from the fluid using the separator; and conveying the fluid from the separator to the nozzle using the fluid mover. The arm and/or the fluid retrieval device may be remotely installed.

### FIELD OF THE DISCLOSURE

This disclosure relates to the cleaning of containers used for storing engineered fluids by minimizing human entry to those containers.

### BACKGROUND OF THE DISCLOSURE

The construction, completion, and workover of hydrocarbon producing wells often requires a variety of engineered fluids. During drilling of a wellbore, drilling fluids or “muds” may be used to provide well bore lubrication, to cool the drill bit, to protect against corrosion and to provide a pressure head to maintain formation integrity. Later, during completion operations, frac fluids may be utilized to increase the flow out of subsurface formations. Drilling fluids and frac fluids are merely illustrative of the various fluids that may need to be transported, stored, utilized, and recovered during well construction or completion.

In many instances, the engineered fluids used in these applications include a carrier fluid and an entrained component. For example, a frac fluid may include diesel and sand. Also, a drilling fluid may include water or oil and entrained solids. During use, these engineered fluids may be stored in tanks, pits, and other enclosed or open spaces that will hereafter be referred to as containers. In some instances, these fluids may remain stored for a period sufficient for the entrained material to settle from the carrier fluid.

Conventionally, human personnel enter a fluid containing structure to clean the residual material from the structure surfaces. The present disclosure provides methods and devices for cleaning such containers while minimizing or eliminating need for human entry into those structures.

### SUMMARY OF THE DISCLOSURE

In aspects, the present disclosure provides a system for cleaning a container. The system may include a fluid source supplying an initial amount of a fluid; a nozzle that sprays the fluid onto a surface of the container; an arm that moves the nozzle in at least two directions in the container and secured to a support positioned at least partially outside of the container; a fluid retrieval device that draws the fluid and an entrained material out of the container; a separator that receives the fluid and entrained material from the fluid retrieval device and removes at least some of the entrained material from the fluid; and a fluid mover receiving the fluid from the separator and flowing the fluid to the nozzle.

In aspects, the present disclosure also provides a method for cleaning a container. The method may include securing an arm to a support positioned at least partially outside of the container, the arm being configured to move a nozzle in at least two directions; spraying a fluid onto an inner surface of the container using the nozzle; drawing the fluid and an entrained material out of the container using a fluid retrieval device; removing at least some of the entrained material from the fluid using a separator; and conveying the fluid from the separator to the nozzle using a fluid mover.

In aspects, the present disclosure provides a method for cleaning a container that may include securing an arm to a support positioned at least partially outside of the container, the arm being configured to move a nozzle in at least two directions; remotely installing a fluid retrieval device in the container; spraying a fluid onto an inner surface of the container using the nozzle; and drawing the fluid out of the container using the fluid retrieval device.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic side view of a top mounted cleaner installed using minimal human entry according to one embodiment according to the present disclosure;

FIG. 2 schematically illustrates a closed loop cleaning system according to one embodiment according to the present disclosure;

FIGS. 3A and 3B schematically illustrate an installation device according to one embodiment according to the present disclosure;

FIG. 4 shows a schematic side view of a side mounted cleaner installed using minimal human entry according to one embodiment according to the present disclosure;

FIG. 5 shows a schematic side view of a side mounted cleaner installed using a selectively energized anchor according to one embodiment according to the present disclosure;

FIG. 6 shows a schematic side view of a cleaner mounted using an anchor connecting to a pre-existing structure according to one embodiment according to the present disclosure;

FIG. 7 shows a schematic side view of a cleaner mounted to a conveyance device according to one embodiment according to the present disclosure; and

FIG. 8 shows a schematic side view of a cleaner mounted to a mobile platform according to one embodiment according to the present disclosure.

### DETAILED DESCRIPTION

The present disclosure is related to methods and devices for cleaning containers used for storing fluids with minimal human entry. The fluids may include naturally-occurring fluids, processed fluids, and/or engineered fluids. One non-limiting example of a naturally-occurring fluid is crude oil, or any hydrocarbon recovered from a subsurface formation. In one aspect, the present disclosure related to methods and devices for cleaning containers used for storing engineered fluids with minimal human entry. For the purposes of the present disclosure, an engineered fluid may include a base or carrier fluid and an entrained secondary component that may precipitate or settle out of the carrier fluid. Illustrative, but not limiting, examples of engineered fluids include drilling fluids, lost circulation material (LCM), frac fluids, and brines. These fluids may be liquids, liquid mixtures or other fluid-like materials, such as gels or slurries. The present disclosure is susceptible to embodiments of different forms. The drawings show and the written specification describes specific embodiments of the present disclosure with the understanding that the present disclosure is to be considered an exemplification of the principles of the disclosure, and is not intended to limit the disclosure to that illustrated and described herein.

Naturally-occurring fluids, processed fluids, and/or engineered fluids may be stored in several different containers during transportation to and from a rig or prior to use. These storage containers may require periodic cleaning to remove sediment, i.e., the entrained solids that have settled out of the carrier fluid. The type of cleaning may depend on the anticipated use of the storage container. For instance, if the storage container is to store the same type of fluid, then the cleaning may be performed to dislodge and remove most of the sediment. However, if the storage container is to store a different fluid, then the storage container may need to be cleaned to remove substantially all of the previously stored fluid. Disclosed herein are devices and related methods for cleaning such storage containers while minimizing human entry into those containers.

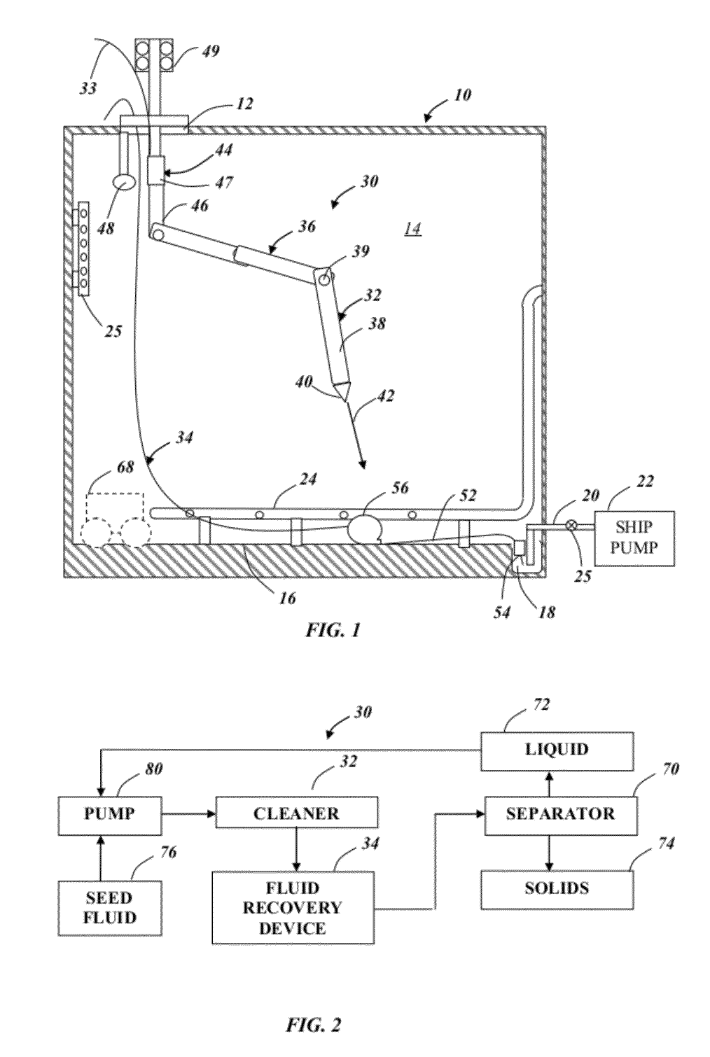

Referring now to FIG. 1, there is schematically shown a side view of a storage container 10 that may be cleaned with minimal human entry. The container 10 may include a hatch or entry 12 at the top or upper wall that provides downward access to an interior space 14. The bottom wall 16 of the container 10 may be inclined to allow fluids to flow to a sump 18. A line 20 may provide fluid communication between the sump 18 and an external fluid pump system 22. Additionally, the container 10 may include an agitator 24 that may be used to circulate fluid in the container 10. Further, the container 10 may include fixtures 25, such as a ladder connected to the container 10.

A cleaning system 30 may be used to remotely clean the interior surfaces of the container 10. In one embodiment, the cleaning system 30 may include a cleaner 32 and a fluid recovery device 34 positioned in the interior space 14. The cleaner 32 may include an articulated arm 36 having sections 38. The sections 38 may be interconnected connected via actuators 39. The actuators 39 may be hydraulic actuators energized by pressurized hydraulic fluid, pneumatic actuators energized by pressurized gas, electric actuators energized by electrical power, etc. At the end of the arm 36 is a nozzle 40 that directs a fluid jet 42 onto the interior surfaces of the container 10. The arm 36 may be configured to move the nozzle 40 along two or more axes (e.g., an x, y, and z axis). In some embodiments, the arm 36 may be a pre-assembled unit that is transported to the container 10. In other embodiments, the arm 36 may be configured to be field-assembled, i.e., transported in sections to the container 10 and assembled prior to remote installation. For example, the segments 38 may be made of a light weight material, e.g., carbon fiber, that allow each segment 38 to be carried by a human. For example, the segment 38 may weigh no more than sixty pounds.

In some embodiments, the cleaner 32 may include an extension section 44 that is made up of one or more segments 46. The segments 46 may be interconnected using joints 47. The joint 47 may use fasteners such as bolts or other locking devices to make the connection.

In some embodiments, other components may be used with the cleaner 32. For example, a fixed monitoring device 48 may be positioned in the container 10 to assist the operator in moving the cleaner 32. The arm 36 may also include a monitoring device (not shown). In embodiments, the monitoring device 48 may be used to identify the location of sediments, residual cleaning fluid, etc. without the use of visible light. For example, an infra-red device may be used. In other embodiments, the monitoring device 48 may be a thermal imaging device. The monitoring device 48 may be configured to pan, rotate, and zoom as needed. For simplicity, the fluid line conveying the cleaning fluid to the nozzle 40, the hydraulic line supplying pressurized fluid to the actuators 39, and other similar features have not been shown. Also, in certain embodiments, a displacement device 49 may be used to move the extension section 44 vertically. For example, the displacement device 49 may be a hydraulic actuator that can move the extension section 44 and connected cleaner 34 upwards and downwards.

The fluid recovery device 34 draws fluid out of the container 10. The fluid recovery device 34 may include a line 52 that has an end 54 configured to draw fluid out of the sump 18. In some embodiments, the fluid recovery device 34 may include a flow device 56, such as a pump, that assists in pumping fluid out of the container 10 via the line 52. The flow device 56 may be energized using electrical power, hydraulic power, pneumatic power or any other available power source.

Referring now to FIG. 2, the cleaning system 30 may be configured as a closed loop system, wherein the cleaning fluid is continually re-circulated in the container 10 (FIG. 1). In one embodiment, the cleaning system 30 includes the cleaner 32, the fluid recovery device 34, a separator 70, and a fluid mover 80. The fluid mover 80 may be a pump or other device configured to supply pressurized fluid to the cleaner 32. The cleaner 32 ejects a high-velocity fluid stream onto the internal surfaces of the container 10 (FIG. 1) that dislodges solids and residual fluids. The fluid recovery device 34 draws the ejected fluid and residual materials out of the container 10 (FIG. 1) and discharges this fluids and entrained materials to the separator 70. The separator 70 separates the discharged fluids into a filtered liquid stream 72 and solids 74. The filtered liquids 72 are conveyed to the fluid mover 80. The separated solids 74 are segregated and stored for later use or disposal. It should be noted that the liquids 72 may have some residual entrained solids and the solids 74 may have some liquid. The pump 80 circulates the filtered liquid 72 to the cleaner 32. Thus, it should be appreciated that the liquid 72 is used and re-used in a cyclical fashion. The process may be initiated using a “seed fluid” 76. The “seed fluid” 76 may be an initial charge of fluid that is the same fluid as the base or carrier fluid that was stored in the container 10 (e.g., diesel, water, synthetic, etc.).

In embodiments, the cleaning system 30 may be a self-contained system that includes a power and/or hydraulic source independent of the vessel, vehicle or facility at which the container is located. Further, in embodiments, the shipboard or facility fluid circulation system may be secured or de-activated, while the cleaning system 30 is operational. That is, the pump system 22 (FIG. 1) and the agitator 24 do not circulate fluid, while the cleaning system 30 is circulating fluid.

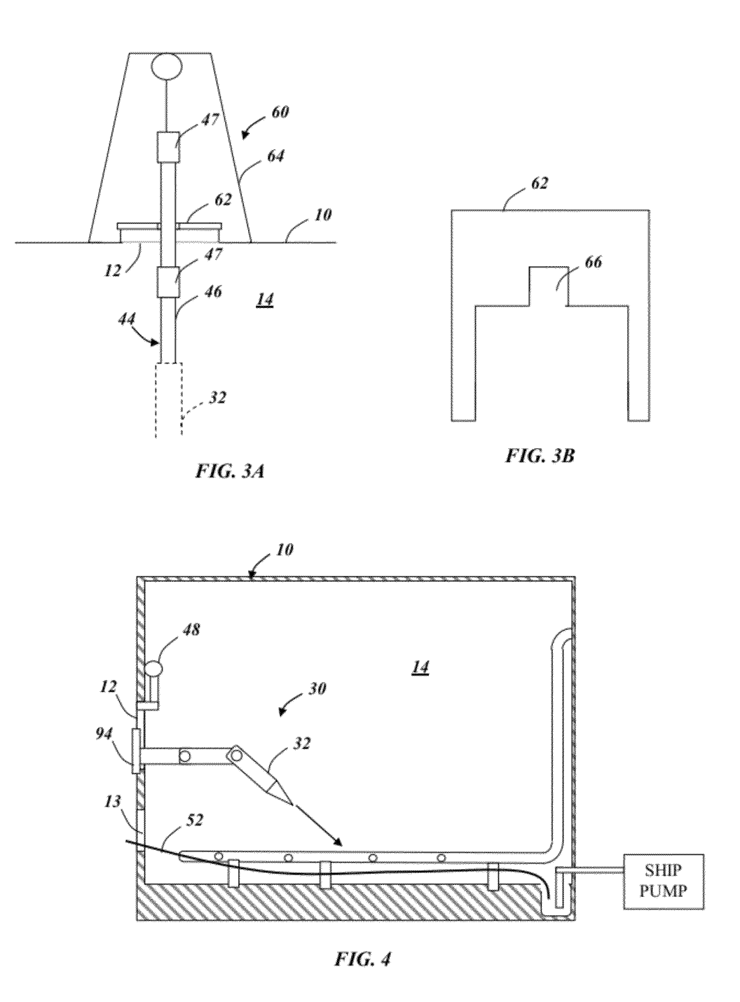

Referring now to FIGS. 3A and 3B, an installation device 60 may be used to insert, suspend, and remove the cleaner 32 in the interior space 14 without human entry into the container 10. The installation device 60 may include a support member 62 and a rig 64. The support member 62 may be a rigid plate to which the cleaner 32 may be secured. The support member 62 may include an opening or slot 66 (as depicted in FIG. 3B). The slot 66 may be shaped complementary to the extension section 44. Moreover, the slot 66 may be sized to prevent passage of the joint 47. The rig 64 may be a frame that supports known devices, such as pulleys suitable for hoisting the cleaner 32 into and out of the container 10.

In one illustrative deployment, the cleaner 32 may be transported to the container 10 as an assembled unit or a disassembled condition. The installation device 60 may positioned over the entry 12 such that the support member 62 partially covers the entry 12. Next, the cleaner 32 may be assembled if needed and an extension segment 46 is connected to the cleaner 32. The cleaner 32 is hoisted up using the rig 64 and lowered into the container 10. During the lowering, the support member 62 is shifted into place so that the slot 66 receives the extension segment 46. Eventually, a joint 47 will rest on the support member 62 during the lower process. Thereafter, another segment 46 may be added to the extension section 44, while the support member 62 supports the cleaner 32. While the support member 62 is shown outside of the container 10, in some embodiments, a portion of the support member 62 may be inside the container. Thereafter, the support member 62 is shifted or otherwise moved to allow the joint 47 to pass. Once the desired elevation is reached for the cleaner 32, the extension section 44 is secured to the support member 62. Next, any necessary power, fluid, and/or hydraulic lines may be installed to make the cleaner 32 operational.

Referring to FIG. 1, a hydraulic line 33 may be coupled to the cleaner 32 to supply fluid to the nozzle 40. Thus, the cleaner 32 may be installed in the container 10 using at least some device, e.g., a controller, power source, support members, hoists, etc., positioned outside of the container; i.e., the cleaner 32 can be “remotely” installed.

In some embodiments, the fluid recovery device 34 may also be positioned in the container 10 without human entry. For example, the arm 36 may include a grasping assembly (not shown) that may be used to move the line 52 and the pump 56 in the container 10 to a desired location. In another embodiment, a robotic device 68 may be used to position the fluid retrieval device 34. Thus, the fluid retrieval device 34 may be installed in the container 10 using at least some device, e.g., a controller, power source, extension rod, etc., positioned outside of the container; i.e., the fluid retrieval device 34 may be “remotely” installed. In other embodiments, the cleaner 30 may not use a fluid retrieval device 34 positioned within the container 10. Rather, the line 52 may be connected to a flange or access port 25 external to the container 10 and upstream of the shipboard or facility pump 22.

Referring now to FIG. 4, there is shown another embodiment of a cleaning system 30 that may be used to remotely clean the interior surfaces of the container 10. In this embodiment, the container 10 may include a hatch or entry 12 at a side wall that provides side entry into the container 10. The cleaning system 30 may include a cleaner 32 positioned in the interior space 14. An articulated support 94 may be used to swing the cleaner 32 into the interior space 14 and support the cleaner 32 during operation. The articulated support 94 may be a hinged device that pivots or swings horizontally. A fixed monitoring device 48 may be positioned in the container 10 or on the arm 46. In FIG. 1, the line 52 of the fluid recovery device was fed through the same entry 12 as the cleaner 32 was positioned. In FIG. 4, the line 52 is fed through a different entry 13. Using two separate entries for the cleaner 32 and the fluid retrieval device 34 may also be done for top entry containers 10, such as that shown in FIG. 1.

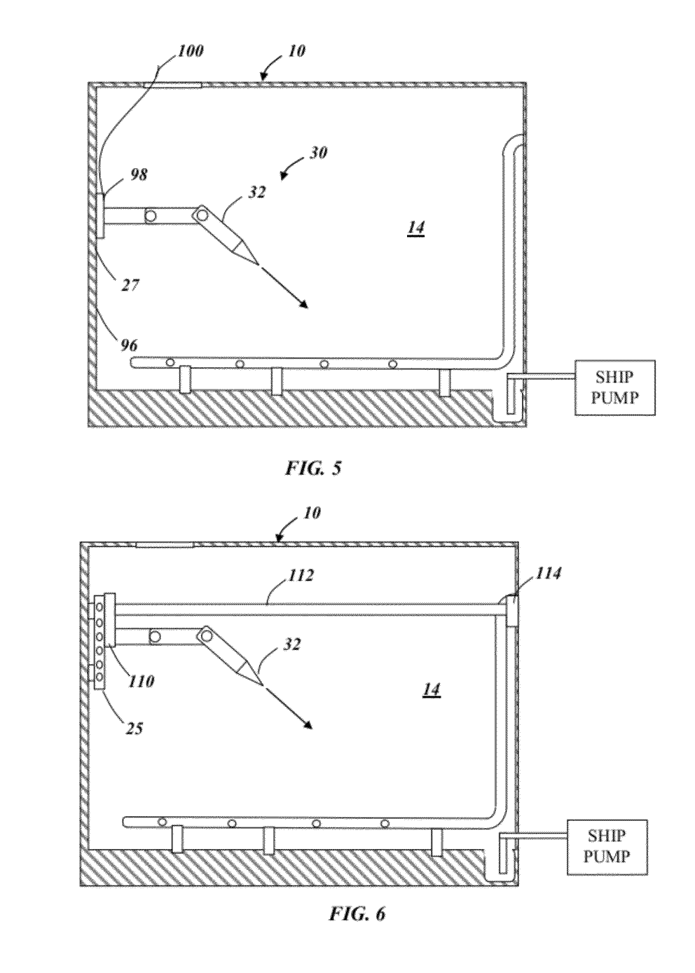

Referring now to FIG. 5, there is shown still another embodiment of a cleaning system 30 that may be used to remotely clean the interior surfaces of the container 10. In this embodiment, the cleaner 32 engages with an interior surface 27 using a selectively activated anchor 98. By selectively activated, it is meant that a signal or energy sent to the anchor 98 shifts the anchor 98 from a dormant or inactive state to an active state. For example, in one embodiment, the anchor 98 may be an electromagnetic device energized using a line 100. Once the cleaner 32 is appropriately positioned in the container 10, a current applied to the anchor 98 generates a magnetic field that locks the cleaner 32 to the surface 96. In other embodiments, energy in the form of pressurized hydraulic fluid may be used to activate the anchor 98. After cleaning operations are completed, the power may be terminated, which deactivates the magnetic field and releases the cleaner 32.

Referring now to FIG. 6, there is shown still another embodiment of a cleaning system 30 that may be used to remotely clean the interior surfaces of the container 10. In this embodiment, the cleaner 32 engages with an interior surface 14 using an anchor 110 configured to engage a pre-existing structure, such as a ladder 25. For example, the anchor 110 may include hooks, clamps, or other similar devices that are adapted to connect with the ladder 25. In some embodiments, the anchor 110 may include a stabilizing member 112 that also engages the container 10 or pre-existing structure in the container 10. As shown, the stabilizing member 112 may be a lateral rod or beam that has an anchoring element 114. The anchoring element 114 may be an electromagnetic device or other suitable anchoring mechanism.

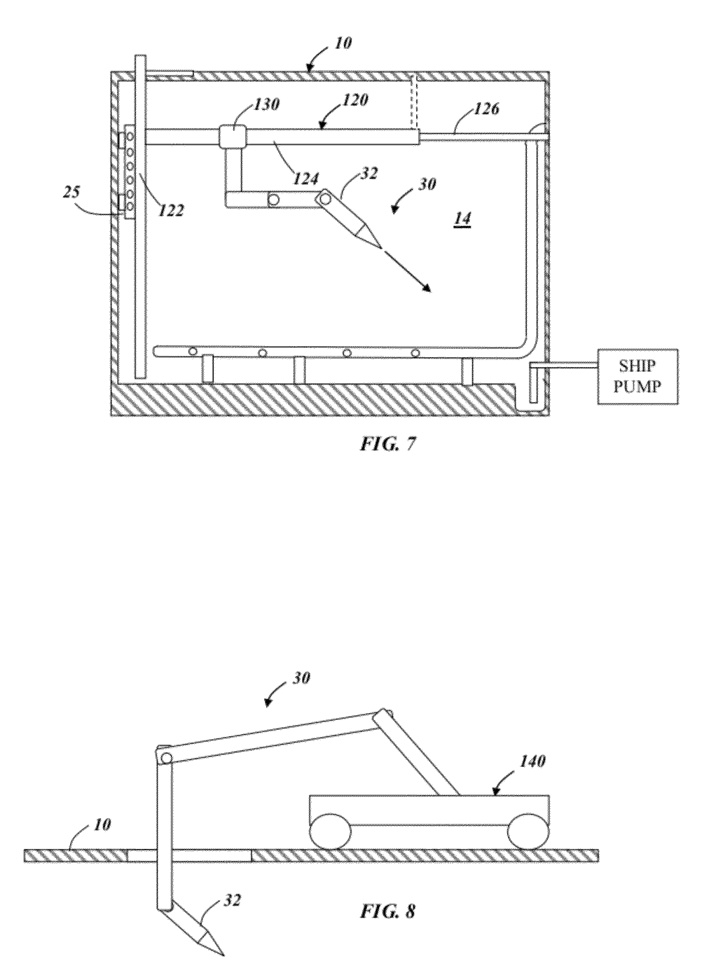

Referring now to FIG. 7, there is shown still another embodiment of a cleaning system 30 that may be used to remotely clean the interior surfaces of the container 10. In this embodiment, the cleaner 32 is suspended in the interior 14 using a support assembly 120 having a first support 122 and a lateral rail 124 having an engagement end 126. The first support 122 may be a vertically oriented beam or brace. The lateral rail 124 may be horizontally aligned and connected at one end to the first support 122. In one embodiment, the engagement end 126 may be a telescopically extendable rod that compressively engages a wall of the container 10. For example, the engagement end 126 may include a piston-cylinder type of arrangement that is actuated using hydraulic power. In another embodiment, the engagement end 126 may engage the container using a different mechanism (e.g., electromechanical anchor). A trolley 130 may be used to connect the cleaner 32 to the rail 124. The trolley 120 may use wheels, rollers, or other suitable devices in order to traverse the rail 124. The first support 122 may also include an anchoring device.

Referring now to FIG. 8, there is shown yet embodiment of a cleaning system 30 that may be used to remotely clean the interior surfaces of the container 10. In this embodiment, the cleaner 32 is suspended on a mobile platform 140. The mobile platform 140 may be a cart or wagon that is moved using human power. In other embodiments, the mobile platform 140 may be self propelled. Additionally, the mobile platform 140 may be constructed to have sufficient weight to remain stationary as the arm 32 is moved in the container 10 and fluid is sprayed.

From the above, it should be appreciated that what has been described includes, in part, a system for cleaning a container. The system may include a fluid source supplying an initial amount of a fluid; a nozzle that sprays the fluid onto a surface of the container; an arm that moves the nozzle in at least two directions in the container and secured to a support positioned at least partially outside of the container; a fluid retrieval device that draws the fluid and an entrained material out of the container; a separator that receives the fluid and entrained material from the fluid retrieval device and removes at least some of the entrained material from the fluid; and a fluid mover receiving the fluid from the separator and flowing the fluid to the nozzle.

From the above, it should be appreciated that what has been described includes, in part, a method for cleaning a container. The method may include securing an arm to a support positioned at least partially outside of the container, the arm being configured to move a nozzle in at least two directions; spraying a fluid onto an inner surface of the container using the nozzle; drawing the fluid and an entrained material out of the container using a fluid retrieval device; removing at least some of the entrained material from the fluid using a separator; and conveying the fluid from the separator to the nozzle using a fluid mover.

From the above, it should be appreciated that what has been described includes, in part, a method for cleaning a container that may include securing an arm to a support positioned at least partially outside of the container, the arm being configured to move a nozzle in at least two directions; remotely installing a fluid retrieval device in the container; spraying a fluid onto an inner surface of the container using the nozzle; and drawing the fluid out of the container using the fluid retrieval device.

While the foregoing disclosure is directed to the one mode embodiments of the disclosure, various modifications will be apparent to those skilled in the art. It is intended that all variations be embraced by the foregoing disclosure.

We claim:

1. A system for cleaning a container, comprising:
a fluid source supplying an initial amount of a fluid;
a nozzle configured to spray the fluid onto a surface of the container;
an arm configured to move the nozzle in at least two directions in the container, the arm being secured to a support positioned at least partially outside of the container;
a fluid retrieval device configured to draw the fluid and an entrained material out of the container;
a separator receiving the fluid and entrained material from the fluid retrieval device and removing at least some of the entrained material from the fluid; and
a fluid mover configured to receive the fluid from the separator and flow the fluid to the nozzle.

2. The system of claim 1, wherein the container includes solids that have settled out of a carrier fluid, and wherein the fluid is substantially the same type of fluid as the carrier fluid.

3. The system of claim 1, further comprising an installation device configured to insert the arm into the container without human entry into the container.

4. The system of claim 1, wherein the container includes a sump, and wherein the fluid retrieval device includes a line in fluid communication with the sump.

5. The system of claim 1, wherein the container includes a sump and a line receiving fluid from the sump, and wherein the fluid retrieval device is configured to connect with a section of the line that is external to the sump.

6. The system of claim 1, further comprising a selectively activated anchor connecting the arm to an inner surface of the container.

7. The system of claim 1, further comprising a connector configured to connect the arm to a pre-existing structure in the container.

8. The system of claim 1, further comprising an extension section connecting the arm to the support, the extension section having a plurality of segments.

9. A method for cleaning a container, comprising:
securing an arm to a support positioned at least partially outside of the container, the arm being configured to move a nozzle in at least two directions;
spraying a fluid onto an inner surface of the container using the nozzle;
drawing the fluid and an entrained material out of the container using a fluid retrieval device;
removing at least some of the entrained material from the fluid using a separator; and
conveying the fluid from the separator to the nozzle using a fluid mover.

10. The method of claim 9, wherein the container includes solids that have settled out of a carrier fluid, and wherein the fluid is substantially the same type of fluid as the carrier fluid.

11. The method of claim 9, further comprising inserting the arm into the container without human entry into the container.

12. The method of claim 9, wherein the container includes a sump, and wherein the fluid is drawn from the sump using a line in fluid communication with the sump.

13. The method of claim 9, wherein the container includes a sump and a line receiving fluid from the sump, and further comprising connecting the fluid retrieval device to connect with a section of the line that is external to the sump.

14. The method of claim 9, further comprising connecting the arm to an inner surface of the container using a selectively activated anchor.

15. The method of claim 9, further comprising connecting the arm to a pre-existing structure in the container.

16. The method of claim 9, further comprising connecting the arm to the support using an extension section having a plurality of segments.

17. A method for cleaning a container, comprising:
securing an arm to a support positioned at least partially outside of the container, the arm being configured to move a nozzle in at least two directions;
remotely installing a fluid retrieval device in the container;
spraying a fluid onto an inner surface of the container using the nozzle; and
drawing the fluid out of the container using the fluid retrieval device.

18. The method of claim 17, further comprising connecting the arm to an inner surface of the container using a selectively activated anchor.

19. The method of claim 17, further comprising connecting the arm to a pre-existing structure in the container.

20. The method of claim 17, wherein the container includes a sump, and wherein the fluid is drawn from the sump using a line in fluid communication with the sump.
